(19) United States
(12) Patent Application Publication
(10) Pub. No.: US 2001/0047304 A1
(43) Pub. Date: Nov. 29, 2001

(54) Method and system for providing product ordering services in a telecommunication system

(75) Inventor: Mika Rinne, Espoo (FI)

Correspondence Address: COHEN, PONTANI, LIEBERMAN & PAVANE, Suite 1210, 551 Fifth Avenue, New York, NY, 10176, US

(73) Assignee: Sonera Oyj

(21) Appl. No.: 09/748,338

(22) Filed: Dec. 22, 2000

(30) Foreign Application Priority Data
Jun. 22, 1998 (FI) PCT/FI98/00546

(51) Int. Cl. G06F 17/60

(52) U.S. Cl. 705/26; 709/219

(57) ABSTRACT

A method and system for implementing a telecommunication system-based service includes a user terminal, such as a personal computer system, which communicates with a network server and a bank server via the telecommunication network. The terminal includes input means for entry of user input data to the system, a mass storage unit, a transportable mass storage medium, and display means for presenting visual information to the user. A multi-media catalog stored on the transportable mass storage medium is read into the terminal from the mass storage unit for presentation of the multi-media catalog to the user on the display means. A displayed product from the multi-media catalog is selected by the user and a telecommunication connection from the terminal to the network server is automatically set up. The selected product is then and thereby ordered from the network server.

### BACKGROUND OF THE INVENTION

1. Field of the Invention

The present invention relates to a method and system for implementing a product ordering and purchase service in a telecommunication system.

2. Description of Related Art

It is of course a long and well-known practice to order products by mail. In the most common form, the desired products are selected by leafing or paging through a mail-order catalog. An order is placed by filling in an order form, including the recipient name, delivery address, invoicing date and the item numbers of the products ordered. The customer sends the order form to the seller, which thereafter delivers the ordered product based on the information contained in the order form.

It is also known to use World Wide Web (WWW) applications for the advertising and sale of a wide variety of products. At present, WWW (i.e. “web”) applications are commonly implemented using the HTML (Hypertext Markup Language) language form structures. The user of a WWW browser is presented for viewing a web page that typically contains a multiplicity of selectable control elements, such as push buttons, text fields and lists. Data is entered using the control elements, whereupon the selections are approved or verified by pressing or selecting or “clicking on” a push button reserved for that purpose. The data is then collectively transmitted to a remote WWW application located on or disposed in conjunction with a WWW server. The WWW application may by way of example be a CGI application, i.e. an application consistent with the CGI (Common Gateway Interface) specification. The application processes the input data, performs the required functions and returns a WWW page. It is also known to use NS-API (Netscape Application Programming Interface) functions instead of a CGI application.

A known technique is to order products via web pages created and transmitted to users or customers via the Internet. The customer establishes a telecommunication connection with such an online or “Internet shop”, browses the available product range and places an order, all the while remaining online.

Another prior-art technique is to publish product information, catalogs and advertisements that are stored on a transportable mass storage medium. In this way, the information can be packed into a small space and can be a accessed or viewed using, for example, a user's personal computer system. One preferred implementation of such a transportable mass storage medium is the CD-ROM.

A fundamental problem with the above-described method of ordering products via web pages is that the customer must have and maintain a telecommunication connection with the seller's WWW server during the entire time of viewing the available range of products, selecting a product to be ordered and, finally, ordering the product. Network capacity is wasted as the customer continues to browse the available products and options while attempting to make a decision on purchase. Moreover, viewing of the range and multiplicity of available products using a web browser is commonly quite slow.

Similarly, ordering of products using a mail-order system is slow, and mail-order catalogs are expensive to produce and distribute. Mail-order catalogs are also an undesirable sales vehicle from the viewpoint of environmental protection. In addition, such catalogs cannot be used to present sound or video content which, for many products, provides a preferred and advantageous presentation and sales vehicle.

Still another problem with mailed advertising disks and product catalogs is that the ordering of the products that are advertised and presented must be carried out in a different system than that used for viewing of the products.

### SUMMARY OF THE INVENTION

It is accordingly the desideratum of the present invention to eliminate, or at least significantly alleviate, the drawbacks and deficiencies of the prior art as for example described hereinabove.

It is a particular object of the invention to provide a method and system for implementing a multi-media catalog that functions both as a pictorial product catalog and as an ordering base for the online ordering for purchase of products via the World Wide Web.

In the inventive method for implementing a service in a telecommunication system, the system includes a terminal which may, by way of preferred example, be a personal computer system or the like. The terminal has an input means for enabling user-communication with the system, a display means for operatively displaying text, graphics, animations and/or video, and a mass storage unit for operatively reading information that is stored on a transportable mass storage medium that is releasably receivable by the mass storage unit. The telecommunication system of the invention comprises a telecommunication network over which the terminal, a network server and a bank server communicate with each other.

In accordance with the invention, a multi-media catalog that is stored on the transportable mass storage medium is read from the mass storage unit into the terminal for presentation to the user or customer via the display means. When the user selects a particular one of the products that are presented in the multi-media catalog, a telecommunication connection from the terminal to the network server is automatically set up or established The selected product is then automatically ordered from the network server.

In an embodiment of the inventive method, the products to be ordered are selected from the multi-media catalog by the user and placed on or entered to an order list, following which a telecommunication connection to the network server is set up. Thus, the telecommunication network is not burdened with a telecommunication connection to the user's terminal until all of the products to be ordered have been selected and stored in the order list. Products initially included in the order list can also be selectively deleted from the list prior to transmission of the order to the network server.

Various embodiments of the inventive method can additionally include one or more other contemplated features. The telecommunication connection can be set up from the terminal to an additional server that provides additional information about a product selected by the user or otherwise presented in the multi-media catalog. The server providing additional information may for example be the server that maintains the web page of the manufacturer of the product presented in the multi-media catalog. Video and/or sound-based content may also be included in the multi-media catalog. The multi-media catalog may additionally include competitions or contests and/or hobbies and/or advertisements and/or notices. A contest may for example be implemented by allotting a product presented in the multi-media catalog as a prize for the winner of the contest or competition.

In addition, the task of charging the customer for a product that has been ordered may be effected by transmitting the instructions and relevant information from the network server to a bank server via the telecommunication network. The telecommunication network may be a TCP/IP-based network such as the Internet.

A system for implementing a telecommunication system-based service in accordance with the invention includes a terminal such, for example, as a personal computer system or the like which communicates with a network server and a bank server via a telecommunication network. The terminal comprises input means for transmitting to the system input data that has been entered by the user, a mass storage unit, display means for presenting visual information to the user, and a transportable mass storage medium, such as a CD-ROM disk, that is receivable by the mass storage unit.

The inventive system comprises means for reading the information stored on the transportable mass storage medium from the mass storage unit into the terminal, and means for automatically setting up a telecommunication connection from the terminal to the network server when a product in a multi-media catalog is to be ordered. The system further includes means for ordering a user-selected product from the network server.

In various embodiments of the inventive system, the terminal may additionally comprise means for maintaining an order list and for gathering from the order list the products user-selected from the multi-media catalog before the setup of a telecommunication connection to the network server. Products initially or already included in the order list may also be selectively removed from the list.

The terminal may further include means for setting up a telecommunication connection from the terminal to an additional server that provides to the terminal additional information about a product selected by the user or otherwise presented in the multi-media catalog. The server providing such additional information may for example be the server that maintains the web page of the manufacturer of the product presented in the multi-media catalog. The terminal may also include sound reproduction means for presenting audio information and content to the user.

The system of the invention may also comprise means for transferring the task of charging the customer for an ordered product to the bank server via a telecommunication connection set up over the telecommunication network between the network server and the bank server.

The invention saves network capacity because signaling from user terminals is transmitted through the telecommunication network only when an order is to be placed. The products are examined and selected by reviewing information locally contained in the user terminal's mass storage unit, and thus without requiring a persistent network connection.

Thus, for example, CD-ROM or other disks on which a multi-media catalog is stored can be distributed in conjunction with various newspapers and/or magazines. While browsing the locally-stored multi-media catalog, the customer can order a given product directly from the network server via the WWW.

Moreover, the invention saves network server capacity because the servers are needed only for as long as it takes to receive and process the customer's order and the relevant charge data. A still further advantage of the present invention, as compared with the prior art, is the notably enhanced speed and ease of use of the product review, selection and ordering processes.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

In the drawings:

FIG. 1 is a diagrammatic block diagram of an illustrative embodiment of the system of the present invention; and

FIGS. 2a and 2b together present a flow chart of an illustrative embodiment of the method of the invention.

### DETAILED DESCRIPTION OF THE CURRENTLY PREFERRED EMBODIMENTS

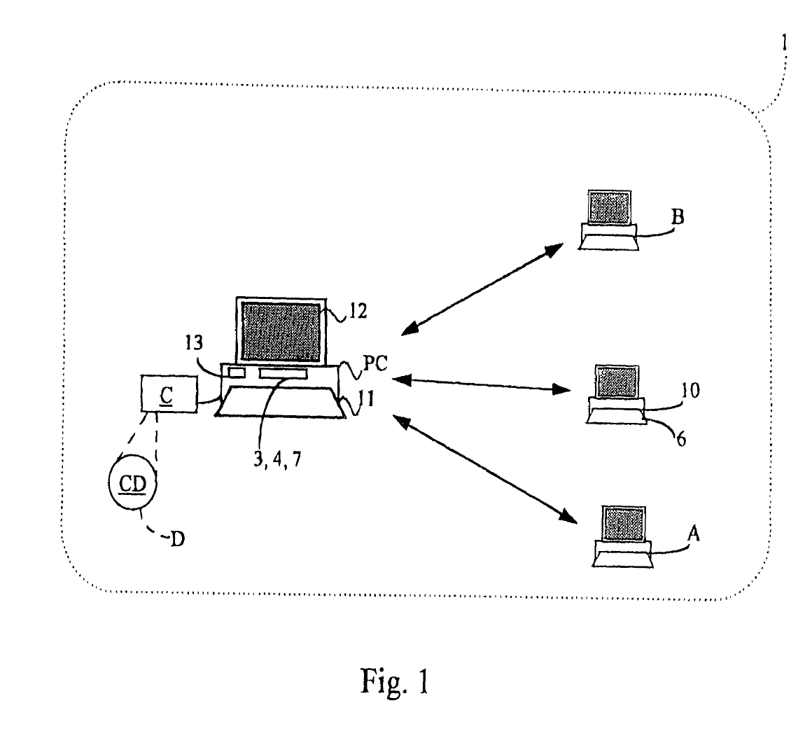

The telecommunication system depicted in FIG. 1, which presents for ease of description a basic implementation and embodiment of the invention, comprises a telecommunication network 1 which includes a bank server B, a network server 10, a server A for providing additional information about a product presented in a multi-media catalog D, and user-accessible terminal equipment for presenting the multi-media catalog to the user. In this particular example, the terminal equipment is a personal computer system PC that utilizes a software-based WWW browser. The terminal PC comprises a mass storage unit C for reading the multi-media catalog D that is locally stored on a portable, removable mass storage medium CD, a keyboard 11 by means of which input data may be entered by the user for, inter alia, accessing the catalog D and for transmission of data through the telecommunication network, and a monitor with an associated graphics and/or video card 12 which is used to present to the user text, graphics, animations, video and other visually-perceptible information or content. The terminal may also be provided with a sound card and accompanying loudspeaker 13 for audio reproduction of sound-based content.

In the FIG. 1 embodiment, a customer using the terminal PC selectively orders a product presented in the multi-media catalog D. The multi-media catalog is read by means of mass stage unit C from the transportable mass storage medium CD into the terminal PC. The multi-media catalog D is presented to the customer by means of the terminal PC and the associated means of visual and audio presentation 12, 13.

The terminal PC may further include means 3 for automatically setting up a telecommunication connection in accordance with the selections made by the user from the multi-media catalog. The terminal PC may also include means 4 for automated ordering of a user-selected product from the network server 10 through the telecommunication connection. The system may additionally comprise means 6 for charging the customer for the ordered product via the bank server B.

The various means described in connection with this illustrative embodiment may be implemented in any known manner and are not therefore described in detail.

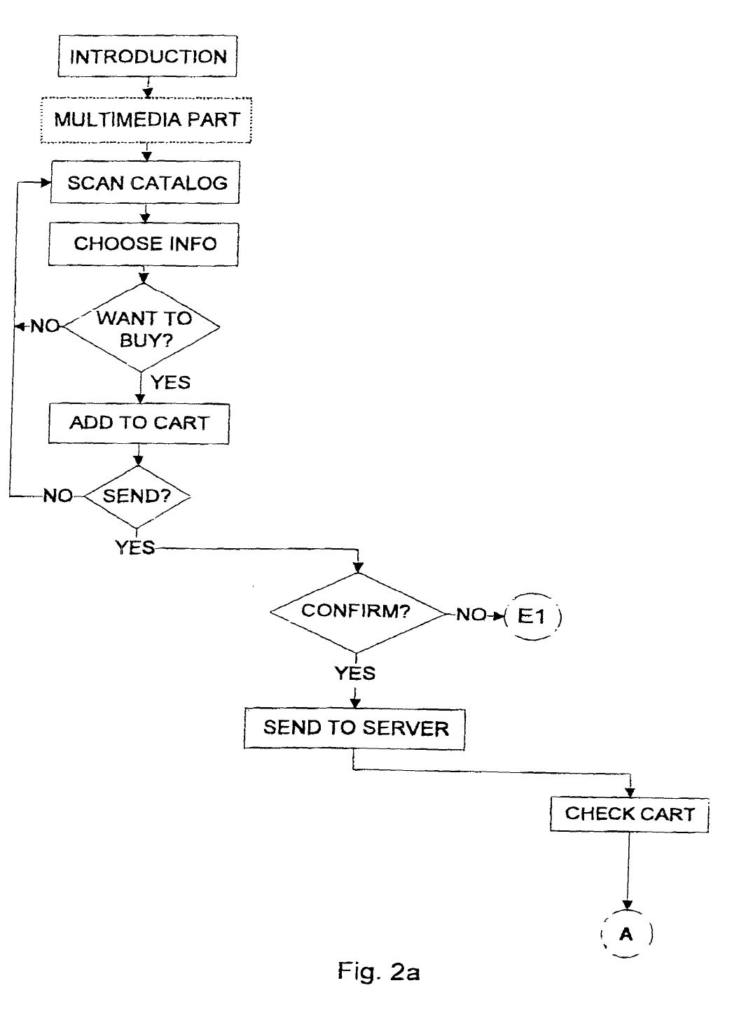

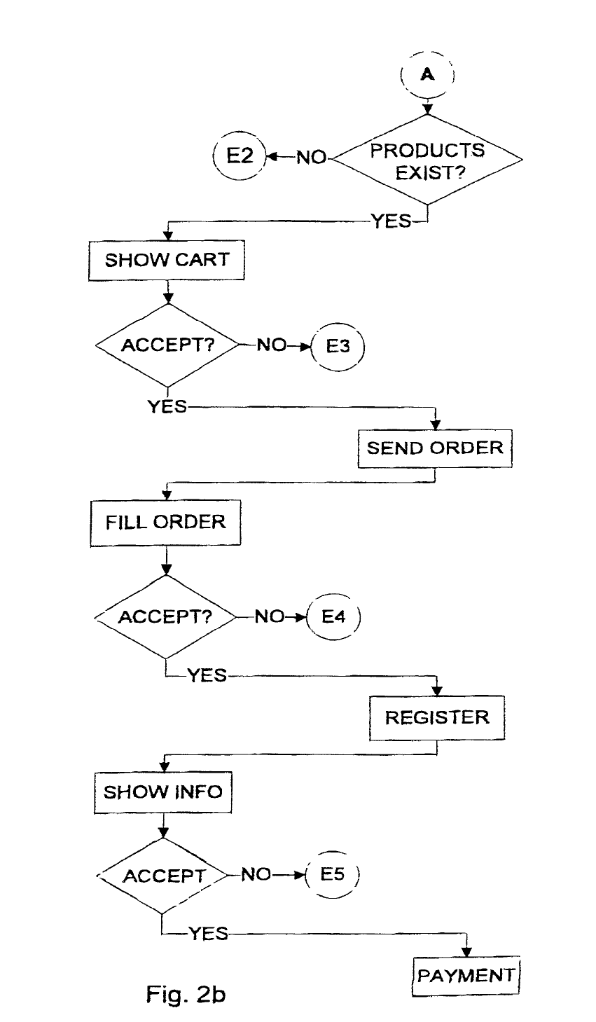

The actions and method steps forming the inventive method and in accordance with the embodiment described in conjunction with the system of FIG. 1 are shown in FIGS. 2a and 2b.

A customer using the terminal PC opens the multi-media catalog D and reads instructions printed on monitor 12 explaining the manner of use of the multi-media catalog (INTRODUCTION).

After the customer has read or skipped the instructions, the actual multi-media catalog is activated (MULTIMEDIA PART) and the customer can then browse the pictorial content of the product catalog (SCAN CATALOG). In the illustrative example described herein and depicted in the drawings, scanning of the product catalog is implemented by having a list of products contained in the multi-media catalog printed or displayed on the monitor 12. The displayed list can be selectively browsed, as by using the arrow keys of the keyboard 11. The scanning of the product catalog may in this example be performed by using predetermined shortcut keys, search commands and other commands provided to assist the user in locating a given product.

To select a particular product in the list, the customer identifies it as an active product and depresses a predetermined or specified key (CHOOSE INFO) on the keyboard 11 or, alternatively, using a mouse or other input device. The system then presents visual and audio information about the product to the customer via the monitor 12 and loudspeakers 13. The customer is then asked whether he/she wants to order the product (WANT TO BUY?). If the customer does not, and so responds in the negative (NO), then the program returns to the scanning function (SCAN CATALOG). If on the other hand the customer does want to order the product presented, and therefore responds in the affirmative (YES), the selected product is added to the order list 5 (ADD TO CART). The terminal PC includes means 7 for maintaining and storing the order list 5; in the herein described embodiment, the means 7 is implemented using a mass storage device and associated software.

The terminal PC asks the customer whether the order stored in order list 5 should be sent further to the network server (SEND?). If the customer responds in the negative (NO), then the software returns to the catalog scanning function (SCAN CATALOG). If on the other hand the customer responds in the affirmative (YES), the WWW browser software in the terminal is activated.

The browser software asks the customer to confirm the order (CONFIRM?). If the customer responds in the negative (NO), then the browser software is closed and scanning of the multi-media catalog D, i.e. the pictorial product catalog, is resumed (El). If the customer answers in the affirmative (YES), then a telecommunication connection to the network server 10 is set up and data identifying or otherwise relating to the products stored in the order list are sent to the network server (SEND TO SERVER). The data is transmitted in a suitable format as required by the telecommunication network 1.

After the network server 10 has received the data identifying the products ordered, it checks the data for completeness, integrity and correctness and as to whether such products are in stock (CHECK CART).

If the data is incomplete or the store has run out of the product ordered ((PRODUCTS EXIST?) / (NO)), the network server sends corresponding information to the user and closes the telecommunication connection (E2). If on the other hand all of the data received by the network server 10 is correct and the product ordered is available in stock ((PRODUCTS EXIST) / (YES)), then the network server sends a message to the terminal PC, and the terminal displays to the customer a list of the products ordered (SHOW CART).

The customer is then asked to accept the order for the products included in the list (ACCEPT?). If the customer responds in the negative (NO), then the order list 5 is emptied and the system resumes presentation to the customer of the multi-media catalog (E3). If the customer's response is in the affirmative (YES), then the network server 10 sends to the WWW browser an order form for the customer to complete (SEND ORDER). The order form is transmitted in the appropriate format to the terminal PC.

The customer then fills in or completes the order form on the terminal PC (FILL ORDER). In the herein-described embodiment, the data to be filled in is the customer's name, information relating to delivery, and information identifying the method or manner of payment to be used to pay the charges for the product ordered. The customer is next asked whether he/she accepts or authorizes transmission to the network server 10 of the data that he/she has given (ACCEPT?). At this stage, therefore, the customer still has an opportunity to cancel the order by responding in the negative (NO), in which case the system again resumes display of the multi-media catalog and the network connection is closed (E4). Upon receipt of a customer response in the affirmative (YES), however, the WWW browser software sends the data filled in on the form to the network server 10.

Having now received the order data, the network server registers the order (REGISTER) and sends information relating to the manner of payment required by the network server to the customer. This information is displayed for the customer (SHOW INFO), after which the customer is asked to confirm the method of payment (ACCEPT?). If the customer's response is in the affirmative (YES), the payment data is sent to the bank server B which will attend to charging the customer on the basis of this data (PAYMENT). Should, however, the customer not accept the method of payment (NO), then the system again resumes presentation of the multi-media catalog and closes the network connection (ES).

If, in the illustrative embodiment hereinabove described, the terminal PC is not connected to the telecommunication network 1, then it is not possible to order products via the network server 10. Nevertheless, products can yet be selected and stored in the order list 5 so that, when the terminal PC is ultimately connected to the telecommunication network 1, an order can then be sent to the network server 10 by reading the product-identifying information stored in the order list 5.

It should in particular be noted and understood that the user interface, as well as the visual and audio aspects of the multi-media catalog, may be implemented in many varied and different ways as general matters of design choice.

Thus, while there have shown and described and pointed out fundamental novel features of the invention as applied to preferred embodiments thereof, it will be understood that various omissions and substitutions and changes in the form and details of the methods described and systems and devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for implementing a service in a telecommunication system which includes a telecommunication network, a network server, a bank server, and a user terminal for communicating with the network server and bank server over the telecommunication network, the terminal having input means for user-entry of input data to the system, a mass storage unit for receiving and operable for reading data stored on a transportable mass storage medium, and display means for presenting visual information to the user, comprising the steps of:
reading into the terminal, from a transportable mass storage medium received in the mass storage unit, a multi-media catalog of products available for purchase that is stored on the transportable mass storage medium for visual presentation of the catalog of available products on the display means of the terminal;
selecting, by a user viewing available products from the multi-media catalog visually presented on the display means, at least one of the presented available products for purchase by the user;
setting up, in automated response to said selecting of the at least one product for purchase, a telecommunication connection from the terminal to the network server over the telecommunication network; and
automatically transmitting, from the terminal to the network server, an order for purchase by the user of the at least one selected product using the set up telecommunication connection over the telecommunication network.

2. A method in accordance with claim 1, wherein said selecting of the at least one product for purchase further comprises the step of placing the at least one selected product on an order list at the terminal, and wherein said setting up of the telecommunication connection is effected in response to placing of the at least one selected product on the order list.

3. A method in accordance with claim 1, further comprising the step of setting up a second telecommunication connection, over the telecommunication network, from the terminal to an additional server that stores information about the at least one selected product for providing to the terminal from the additional server additional information about the at least one selected product for presentation to the user.

4. A method in accordance with claim 1, wherein the multi-media catalog stored on the transportable storage medium includes data reproducible by the terminal to present a video content to the user on the display means.

5. A method in accordance with claim 1, wherein the multi-media catalog stored on the transportable storage medium includes data reproducible by the terminal to present a audio content to the user.

6. A method in accordance with claim 1, wherein the multi-media catalog stored on the transportable storage medium includes data relating to at least one of contests, hobbies, advertisements and notices and reproducible by the terminal for presentation to the user.

7. A method in accordance with claim 1, further comprising the step of setting up a telecommunication connection, over the telecommunication network, between the network server and the bank server for instructing the bank server to charge the user for the at least one product of the order for purchase received from the terminal by the network server.

8. A method in accordance with claim 1, wherein the telecommunication network comprises a TCP/IP-based internet network.

9. A system for implementing a service in a telecommunication system which includes a telecommunication network, a network server, a bank server, and a user terminal for communicating with the network server and bank server over the telecommunication network, the terminal having input means for user-entry of input data to the system, a mass storage unit for receiving and operable for reading data stored on a transportable mass storage medium, and display means for presenting visual information to the user, comprising:
means on the terminal for reading into the terminal, from a transportable mass storage medium received in the mass storage unit, a multi-media catalog of products available for purchase that is stored on the transportable mass storage medium for visual presentation of the catalog of available products on the display means of the terminal;
means on the terminal for setting up, in automated response to user selection of at least one of the available products presented on the display means, a telecommunication connection from the terminal to the network server over the telecommunication network; and
means on the terminal for transmitting, to the network server using the set up telecommunication connection, an order for purchase of the at least one selected product.

10. A system in accordance with claim 9, further comprising means on the terminal for maintaining an order list and for placing the user-selected at least one product on the order list before setting up of the telecommunication connection.

11. A system in accordance with claim 9, further comprising means on the terminal for setting up a second telecommunication connection, over the telecommunication network, from the terminal to an additional server that stores information about the user-selected at least one product for providing to the terminal from the additional server additional information about the at least one selected product for presentation to the user.

12. A system in accordance with claim 9, wherein the terminal further includes sound reproduction means for presenting audio information to the user from the multimedia catalog.

13. A system in accordance with claim 9, further comprising means for establishing a second telecommunication connection, over the telecommunication network, between the network server and the bank server for instructing the bank server to charge the user for the at least one product of the order for purchase received from the terminal by the network server.
